(19) United States
(12) Patent Application Publication
(10) Pub. No.: US 2002/0105259 A1
(43) Pub. Date: Aug. 8, 2002

(54) Area lamp apparatus

(75) Inventor: Daeil Kim, Rivervale, NJ (US)

Correspondence Address: MORGAN LEWIS & BOCKIUS LLP, 1111 PENNSYLVANIA AVENUE NW, WASHINGTON, DC, 20004, US

(73) Assignee: Plasmion Corporation

(21) Appl. No.: 10/045,016

(22) Filed: Jan. 15, 2002

(30) Foreign Application Priority Data
Jan. 17, 2001 (KR) P2001-0002699
May 30, 2001 (KR) P2001-0030092

(51) Int. Cl. H01J 1/62

(52) U.S. Cl. 313/491

(57) ABSTRACT

The present invention discloses an area lamp apparatus, and more specifically, a flat light source wherein a plurality of fluorescent lamps are formed within a single glass substrate. The area lamp apparatus includes front and rear substrates facing into each other and at least a portion of the front and rear substrates contacting each other, a plurality of groves in at least one of the front and rear substrates to form a plurality of discharge channels, a fluorescent layer on surfaces of the groves, a pair of side substrates attached to the front and rear substrates for sealing the discharge channels, and a pair of side electrodes on the side substrates. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

This application claims the benefit of Korean Application Nos. P2001-0002699 filed on Jan. 17, 2001 and P2001-0030092 filed on May 30, 2001, which are hereby incorporated by reference.

### BACKGROUND OF THE INVENTION

1. Field of the Invention

The present invention relates to an area lamp apparatus using gas discharge, and more particularly, to an area lamp apparatus formed of a flat area light source, wherein a plurality of discharge channels are included in a glass substrate. Although the present invention is suitable for a wide scope of applications, it is particularly suitable for high luminance and fluorescent efficiency.

2. Discussion of the Related Art

An area lamp apparatus has been widely used as a light source in liquid crystal displays. The area lamp apparatus may also be used as a general lighting device in the future. FIG. 1 illustrates an area lamp apparatus of the related art. As shown in FIG. 1A, a plurality of tubular fluorescent lamps 101 are evenly arranged within a box 102. A reflector 103 reflecting light diffused from the rear surface to the front surface, and a diffuser 104 uniformly dispersing light to the front substrate are formed on the rear substrate of the box 102. The tubular fluorescent lamp 101 includes a phosphor layer deposited within a glass tube, a mixture of argon gas and mercury sealed in the space inside the glass tube, and metallic electrodes at each end of the glass tube.

An improved structure of the related art area lamp apparatus is shown in FIG. 1B. The improved structure includes a single box formed of a glass substrate, rather than being formed of an area light source with a plurality of tubular fluorescent lamps and U-shaped metallic electrodes. On front and rear glass substrates 105 and 109, a phosphor layer 106 is formed thereon. An electrode 107 is mounted on the side. A frame glass 108 is attached on the electrode 107. Further, an exhaust tube 110 and a lead are formed on the side of the lamp apparatus.

The above-mentioned related art area lamps have the following disadvantages. In the apparatus shown in FIG. lA, a reflector and a diffuser should be used for uniformity in luminance, thereby requiring additional cost for additional parts and assembling. The apparatus shown in FIG. 1B is advantageous in that it is formed in a single body. However, the phosphor layer 106 is deposited on the flat surface, which amounts to only a small portion of the phosphor layer. Thus, high luminance and efficiency cannot be achieved in the related art lamp apparatus.

### SUMMARY OF THE INVENTION

Accordingly, the present invention is directed to an area lamp apparatus that substantially obviates one or more of problems due to limitations and disadvantages of the related art.

Another object of the present invention is to provide an area lamp apparatus of high luminance and high fluorescent efficiency.

Another object of the present invention is to provide an area lamp apparatus that can be fabricated at a low cost.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an area lamp apparatus of the present invention includes front and rear substrates facing into each other and at least a portion of the front and rear substrates contacting each other, a plurality of groves in at least one of the front and rear substrates to form a plurality of discharge channels, a fluorescent layer on surfaces of the groves, a pair of side substrates attached to the front and rear substrates for sealing the discharge channels, and a pair of side electrodes on the side substrates.

In another aspect of the present invention, an area lamp apparatus of the present invention includes front and rear substrates facing into each other and at least a portion of the front and rear substrates contacting each other, a plurality of groves at the rear substrate to form a plurality of discharge channels, a fluorescent layer on surfaces of the groves, and a pair of side electrodes on external surfaces of the front and rear substrates at both ends of the groves.

In a further aspect of the present invention, an area lamp apparatus of the present invention includes a substrate, at least one discharge channel in the substrate, a fluorescent layer on a surface of the discharge channel, a pair of side substrates attached to the discharge substrate for sealing the discharge channels, and a pair of side electrodes on the side substrates.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIGS. 1A and 1B illustrate area lamp apparatuses of a related art;

FIG. 2 is an expanded perspective view of an area lamp apparatus according to a first embodiment of the present invention;

FIGS. 3A to 3C illustrate a perspective view and transverse cross-sectional views of FIG. 2 taken along lines IIIB-IIIB and IIIC-IIIC;

FIG. 4 illustrates an expanded perspective view of a side electrode substrate in FIG. 2;

FIG. 5 illustrates an expanded perspective view of a side electrode substrate according to a second embodiment of the present invention;

FIG. 6 is an expanded perspective view of the area lamp apparatus according to a third embodiment of the present invention;

FIG. 7 is an expanded perspective view of the area lamp apparatus according to a fourth embodiment of the present invention;

FIG. 8 is an expanded perspective view of the area lamp apparatus according to a fifth embodiment of the present invention;

FIGS. 9A to 9D are expanded perspective view s of the area lamp apparatus according to a sixth embodiment of the present invention;

FIG. 10 is an expanded perspective view of the area lamp apparatus according to a seventh embodiment of the present invention;

FIGS. 11A to 11C are expanded perspective views of the area lamp apparatus according to an eighth embodiment of the present invention;

FIGS. 12A to 12C are a perspective view of the rear substrate and a perspective view and a cross-sectional view of the area lamp apparatus according to a ninth embodiment of the present invention;

FIGS. 13A and 13B are detailed views describing a method of arranging the protrusions formed on a ridge;

FIGS. 14 to 17 illustrate various shapes of electrodes that may be applied to the area lamp of the present invention; and

FIG. 18 illustrates the shapes of various hollow electrodes.

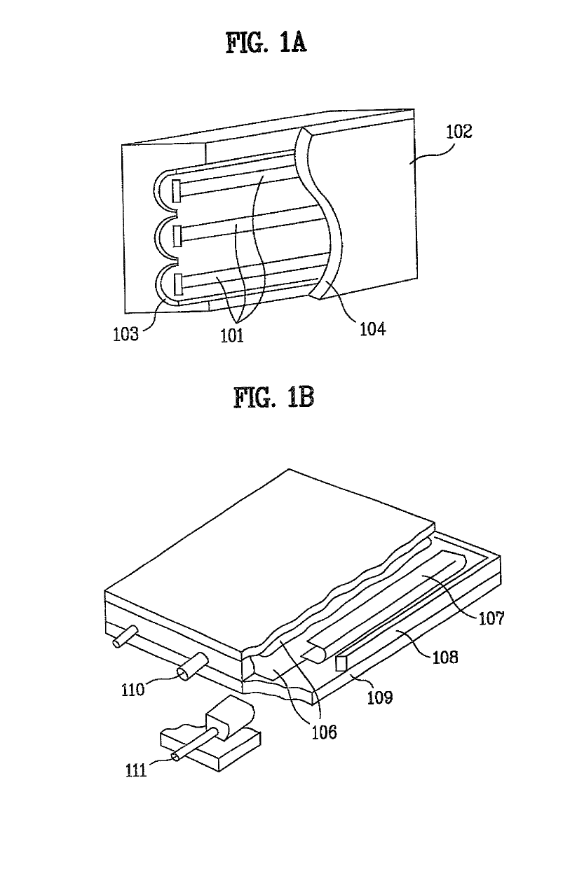

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts. Also, detailed descriptions regarding the same or like parts will be omitted for convenience.

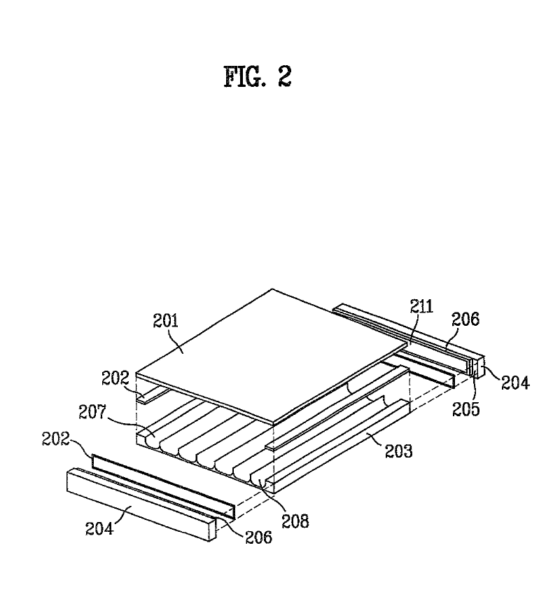

FIGS. 2 to 4 illustrate detailed structures of an area lamp apparatus according to a first embodiment of the present invention. The area lamp apparatus of the present invention includes a front substrate 201, a rear substrate 203, and a pair of side electrode substrates 204. The front and rear substrates 201 and 203 and the side electrodes 204 are attached by a sealant 202.

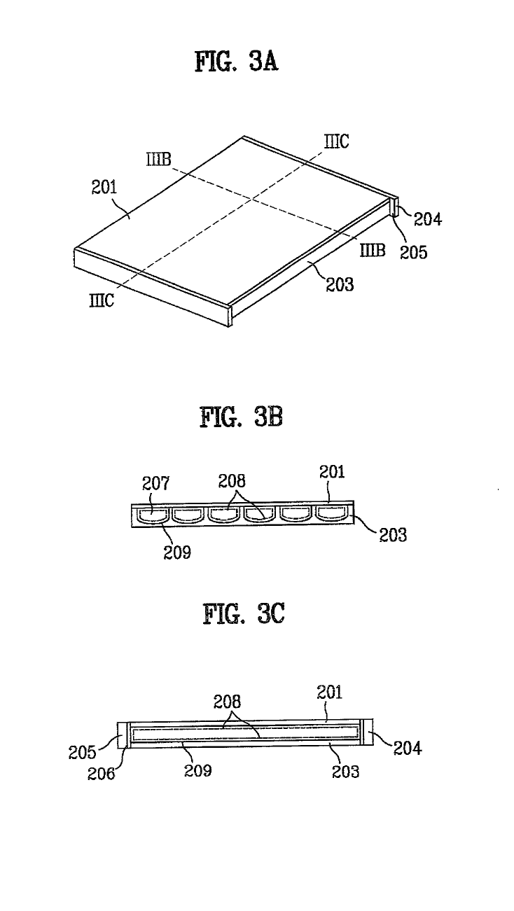

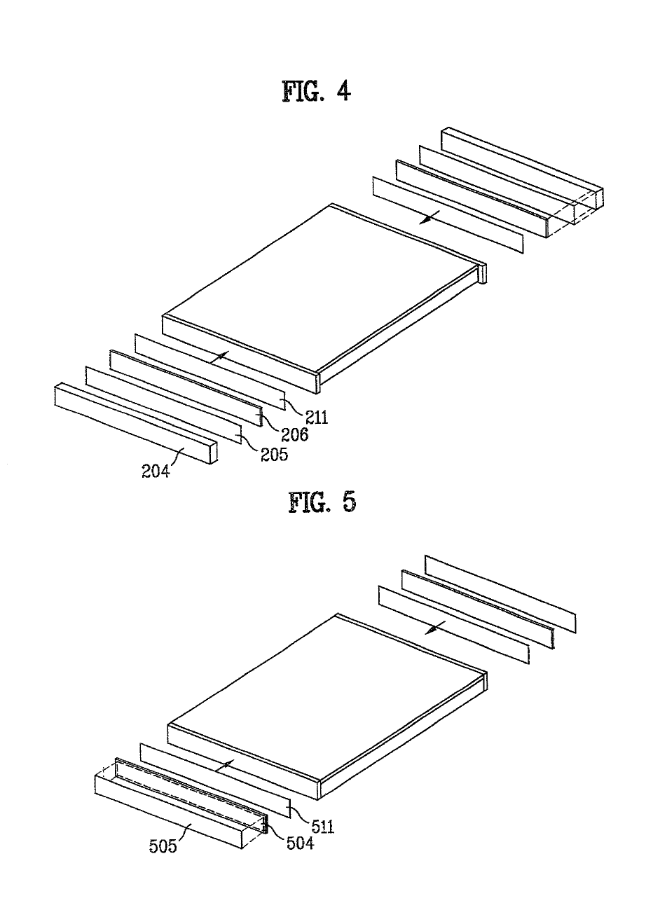

A plurality of channels 207 are formed in the rear substrate 203. A phosphor layer 208 is formed on the channels 207 of the rear substrate 203. The channels 207 are shaped into tubular forms, so that light can be emitted more effectively from the larger area. A visible light reflector 209 (shown in FIG. 3) formed of one of ZrO₂, BN, and TiO₂ is formed between the rear substrate 203 and the phosphor layer 208 to minimize loss of light through the bottom of the rear substrate 203. An external voltage is applied to the inside of the lamp through the side electrode substrate 204 (shown in FIG. 4). A metallic electrode 205 is formed on each side electrode substrate 204 by using one of a sputtering method, a vacuum evaporation method, and a thick film printing method. A dielectric layer 206 is then formed by using a thick film printing method. A protective layer 211, such as magnesium oxide (MgO), is formed to reduce a discharge voltage and improve durability, by using one of the aforementioned methods.

FIG. 5 illustrates a structure of the side electrode substrate in a second embodiment of the present invention. Without forming the separate dielectric layer 206 (shown in FIG. 4), a side glass substrate may be used as a dielectric layer. In this case, however, the side substrate should to be thinner than the side glass substrate 204 used in FIG. 4 in order to prevent the driving voltage from being excessively high.

Four glass substrates with the above-described structures are sealed with a sealant (not shown) to form a lamp apparatus having a box shape. Then, after an exhaustion process and a gas injection process, an inert gas is injected and sealed into the box, thereby completing the area lamp apparatus. In this case, the injected gas includes one of argon and mercury, neon, and xenon.

In driving the area lamp apparatus with the above-mentioned structures, several hundreds of volts to several kilovolts of sine waves or pulse waves are externally applied to the side electrodes on each side of the area lamp apparatus. Then, discharge occurs in the gaseous space formed between the side electrodes. Subsequently, ultraviolet light following the discharge excites the phosphor layer deposited on the surface of the channels in the rear substrate and the lower surface of the front substrate, thereby emitting visible light.

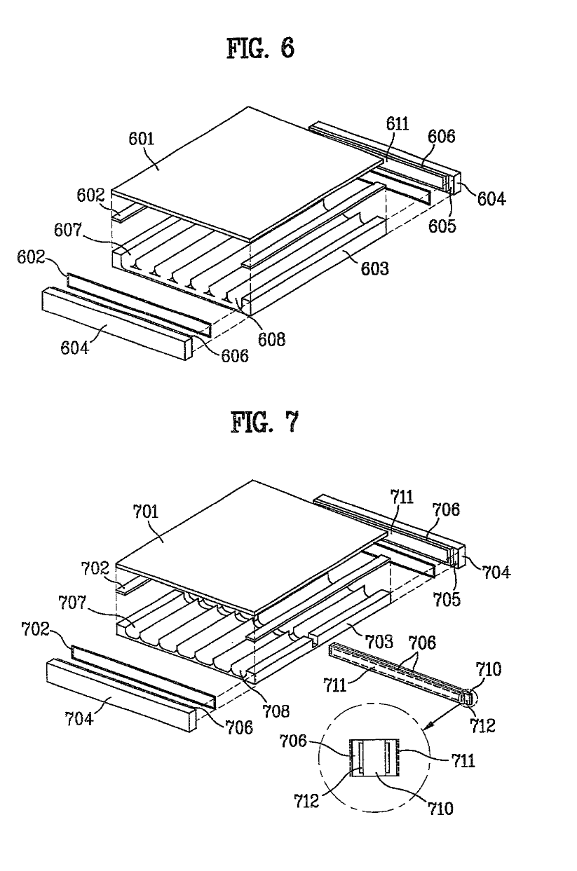

FIG. 6 is an expanded perspective view of the area lamp apparatus according to a third embodiment of the present invention. In the third embodiment, portions of each channel formed in the rear substrate 603, which are adjacent to the electrodes 605, are removed in order to provide sufficient gaseous space for an increased efficiency of the plasma generation.

FIG. 7 is an expanded perspective view of the area lamp apparatus according to a fourth embodiment of the present invention. In the third embodiment, a driving voltage is prevented from being excessively high by controlling the length of the discharge channel (i.e., the distance between the two electrodes). In addition, a middle electrode substrate 710 is inserted in the middle of the rear substrate 703 for large-sized area lamp apparatuses. Herein, a single rear substrate 703, or a plurality of identical substrates attached to one another may be used as a rear substrate. A channel for inserting the middle electrode substrate 710 may be formed at one or more regions of the front substrate 701 or the rear substrate 703. A single insertion hole may be formed on the front substrate or the rear substrate. Alternatively, a plurality of insertion holes may be formed in order to insert a plurality of the middle electrode substrates 710. An area lamp apparatus using a single middle electrode substrate 710 is illustrated in FIG. 7. In this embodiment, a channel is formed in the middle of the rear substrate 703 in order to insert a middle electrode therein. As shown in FIG. 7, when longer discharge channels are formed, a plurality of middle channels perpendicular to the discharge channels are formed at an interval, thereby forming a middle electrode at each middle channel. As shown in an enlarged cross-sectional view in FIG. 7 the middle electrode substrate is formed of a middle electrode 712, a dielectric layer 706, and an MgO protective layer 711 sequentially formed on each side of the middle electrode substrate. A voltage of the equal signals should be applied to each middle electrode on both sides of the middle electrode substrate in order to prevent the substrate from being damaged by an electric field.

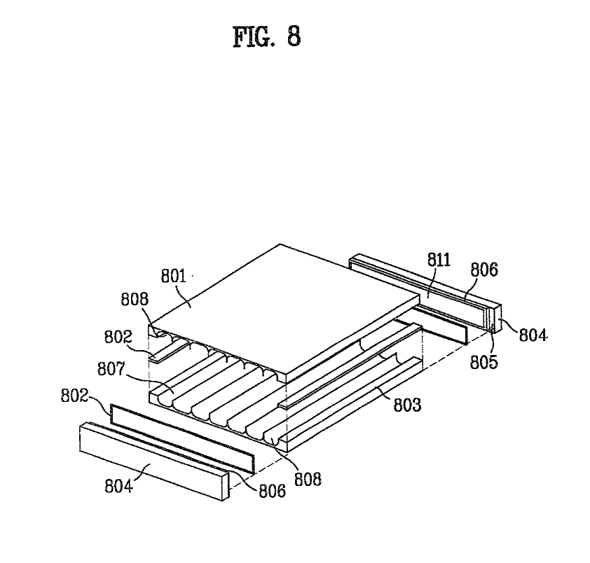

FIG. 8 is an expanded perspective view of the area lamp apparatus according to a fifth embodiment of the present invention. In this embodiment, a discharge space and the surface of the phosphor layer 808 are expanded in order to form an area lamp apparatus providing higher luminance and efficiency. Herein, channels identical to those within the rear substrate 803 are formed within the front substrate 801.

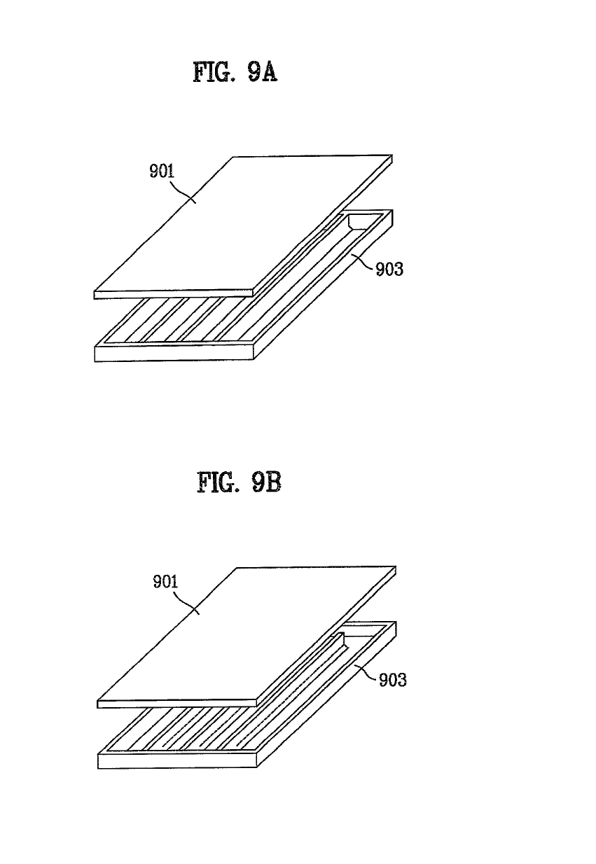

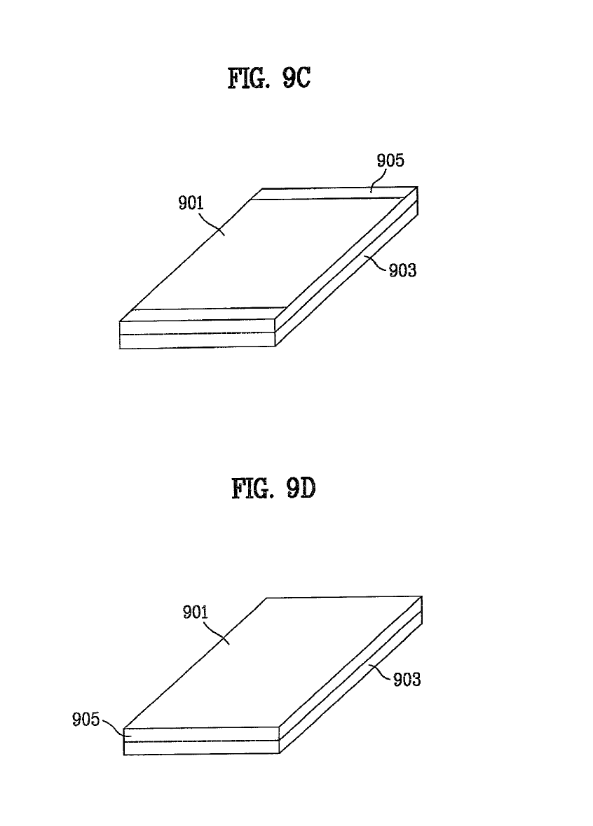

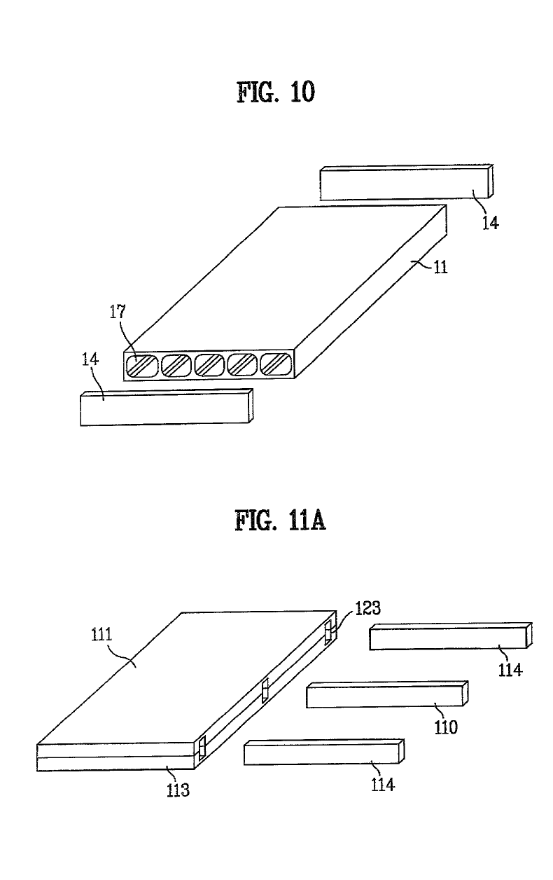

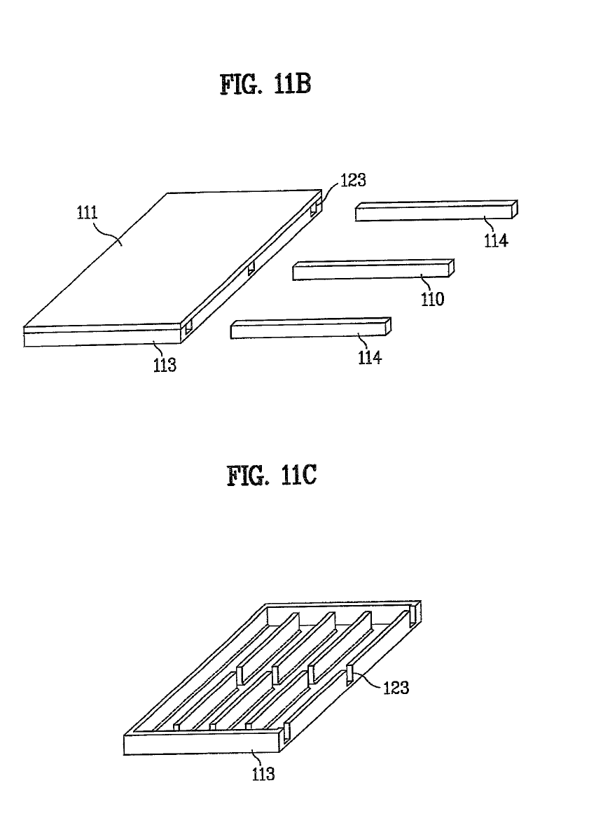

As a sixth embodiment of the present invention, FIGS. 9A to 9D are perspective views of the area lamp apparatus using external electrodes. In FIG. 9A, the length of each channel formed in at least one of an upper substrate 901 and a lower substrate 902 is approximately equal to the distance between the two side electrodes. In FIG. 9B, the length of each channel formed on at least one of the upper substrate and the lower substrate is shorter than the distance between the two side electrodes since the channels are not extended all the way to the two side electrodes. As shown in FIGS. 9A and 9B, the upper substrate and the lower substrate are put together, and metallic electrodes enclose portions of the outer surfaces of the left and right sides, thereby forming the area lamp apparatus as shown in FIGS. 9C and 9D. Having metallic side electrodes covering a portion of the glass box, this structure is advantageous in that the glass box itself may be used as a dielectric. As shown in FIG. 9D, the metallic electrodes may be formed only on the side surfaces. However, a portion of the metallic electrode may also cover a portion of the front substrate 901 and the rear substrate 903, as shown in FIG. 9A. In addition, as shown in 9C and 9D, the metallic electrode may be formed by attaching a conductive tape with an adhesive, depositing a metal by using a sputtering method, or using a plating method. In FIGS. 9A and 9B, the front substrate is illustrated as a thin flat glass substrate without any phosphor channel. However, this embodiment illustrated in FIGS. 9A to 9D may be applied to the area lamp apparatus for a glass substrate having a plurality of phosphor channels formed on the rear substrate 903.

FIG. 10 is an expanded perspective view of the area lamp apparatus according to a seventh embodiment of the present invention. As shown in FIG. 10, a plurality of discharge channels 17 are formed within a thick substrate 11, and a substrate 14 having an electrode is attached on each side surface, thus facilitating a fabrication process of the area lamp apparatus. In this case, phosphor may be formed as a slurry, so that the phosphor may be deposited on the channel walls by pouring the slurry into the channels.

FIGs. 11A to 11C are expanded perspective views of the area lamp apparatus according to an eighth embodiment of the present invention. As shown in FIG. 11A, electrode insertion holes 123 are formed in each side of a front substrate 111 and a rear substrate 113, so that side electrode substrates 114 and a middle electrode 110 are inserted therein. Alternatively, as shown in FIG. 11B, the electrode insertion holes 123 may be formed only in the rear substrate 113 having a plurality of phosphor channels. Thus, these are electrode insertion holes 123 in the front substrate 111. Then, the side electrode substrates 114 and the middle electrode substrate 110 are inserted therein. FIG. 11C is the rear substrate having electrode insertion holes 123, which may be applied to both the front substrate 111 and the rear substrate 113 in FIG. 11A and the rear substrate 113 in FIG. 11B.

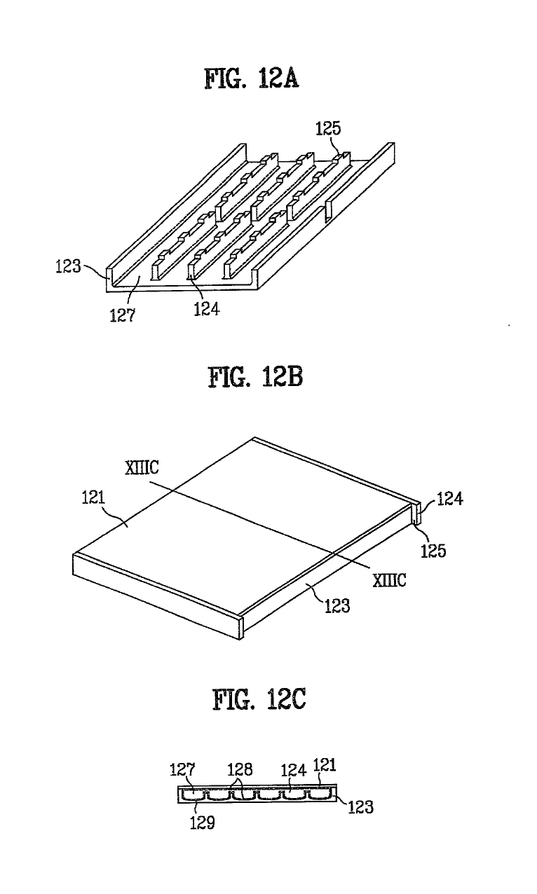

FIGS. 12A to 12C are a perspective view of the rear substrate and a perspective view and a cross-sectional view of the area lamp apparatus according to a ninth embodiment of the present invention having protrusions on each edge of the channel. In the channels according to the embodiment described in FIG. 3, the uppermost portions of the channels formed on the rear substrate 203 directly contact the front substrate 201, so that the contacted phosphoric region may not function properly. This causes the uppermost portions of the channels on the rear substrate 203 to be displayed as stripes on the front substrate 201. In order to resolve this problem, protrusions 125 are formed on each ridge 124 for forming channels 127, thereby minimizing a contact surface between the ridges and the front substrate 121. More specifically, upper portions of the channels of the rear substrate 123 are removed to form protrusions 125, so that visual light emitted from a phosphor layer 128 of the rear substrate 123 becomes more uniform. FIG. 12B is a perspective view of the area lamp apparatus having the rear substrate described in FIG. 12A for providing uniform luminance. Herein, in order to avoid a contact with the front substrate 121, ridges 124 for forming the channels are made to be slightly lower so that uniformity in the dispersion of luminance is improved. FIG. 12B is a transverse cross-sectional view taken along line XIIC-XIIC thereof. In FIG. 12B, the ridges 124 for forming channels 127 do not contact the front substrate 121. The phosphor layer 128 is also deposited on the ridges 124. A reflector 129, which reflects light dispersed from the lower surface of the rear substrate to the upper surface, is fixed on the channels 127 in the rear substrate 123. In addition, a diffuser (not shown) that uniformly disperses light may be formed in order to provide uniform luminescence.

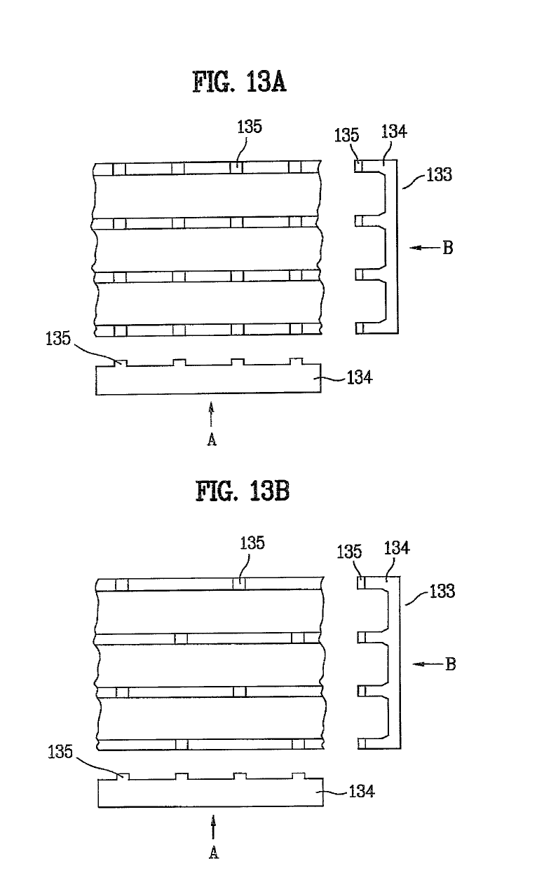

FIGS. 13A and 13B are detailed partial views of the protrusions formed on the ridge shown in FIG. 12A. In FIG. 13A, the protrusions 15 are arranged on a portion of the ridges in a lattice pattern. Herein, cross-sectional views taken in directions “A” and “B” are illustrated on the bottom and the right side of FIG. 13A, respectively. In FIG. 13B, the protrusions 15 adjacent to a portion of the ridges are arranged in a checkerboard pattern. Herein, cross-sectional views taken in direction “A” and “B” are illustrated on the bottom and the right side of FIG. 13B, respectively. In addition to the above arrangement in the protrusions, other arrangements for the protrusions 15 may be realized in the present invention as long as the arrangement provides a uniform dispersion of visual light and supports the front substrate accordingly.

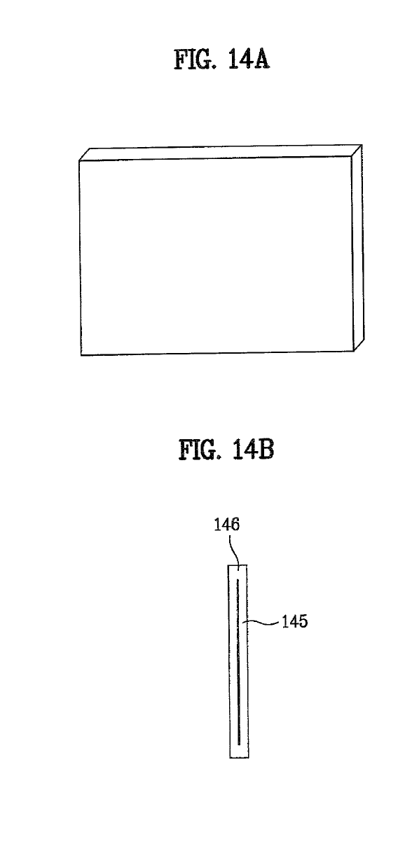

The side electrodes or the middle electrodes of the present invention may be formed in various shapes in order to improve efficiency in luminescence. FIGS. 14 to 17 illustrate a variety of electrode shapes that may be applied in the area lamp apparatus of the present invention. These drawings illustrate electrodes formed by depositing a dielectric layer made of ceramic on the entire surface of a flat metal or metals having protrusions of a wide variety of shapes. More specifically, an enamel technique is applied to metals formed into various different shapes. FIGS. 14A and 14B illustrate a flat metallic side electrode 145 and a dielectric layer 146 for the area lamp apparatus in the present invention. In FIGS. 14A and 14B, a metal plate 145 and a dielectric layer 146 surrounding the metal plate 145 are used as a side electrode substrate and a middle electrode substrate.

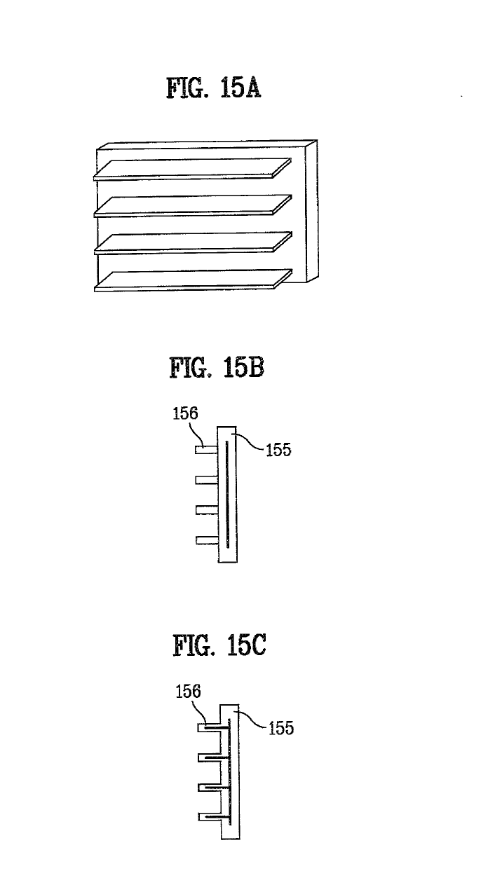

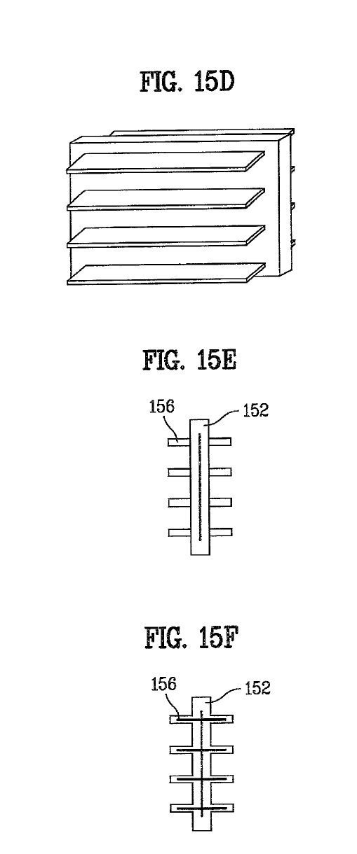

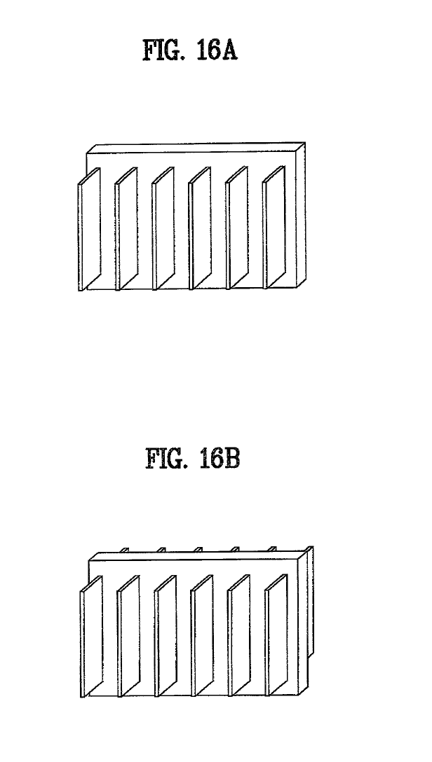

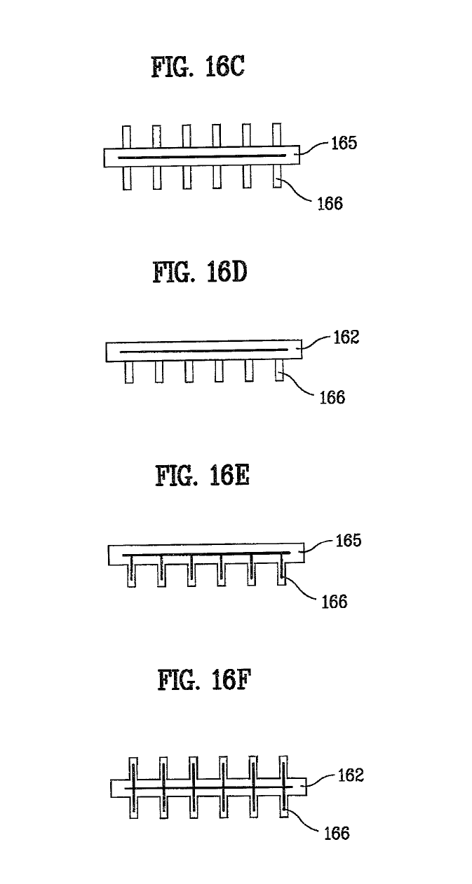

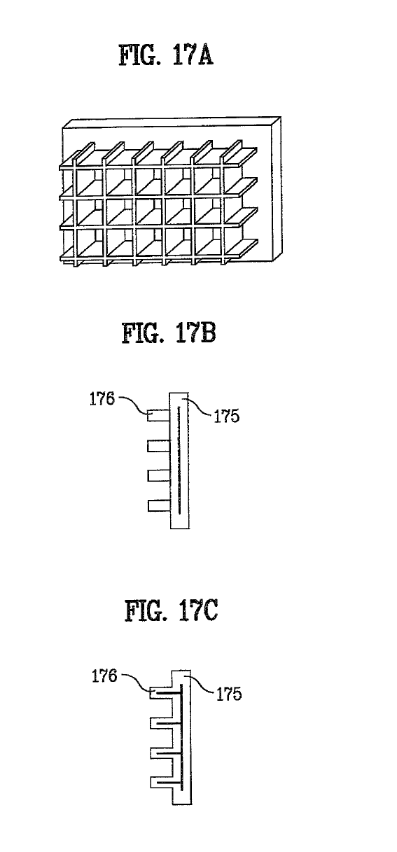

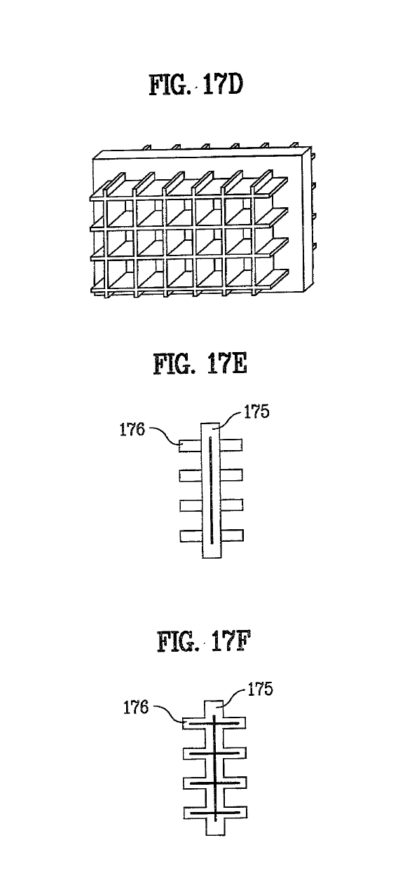

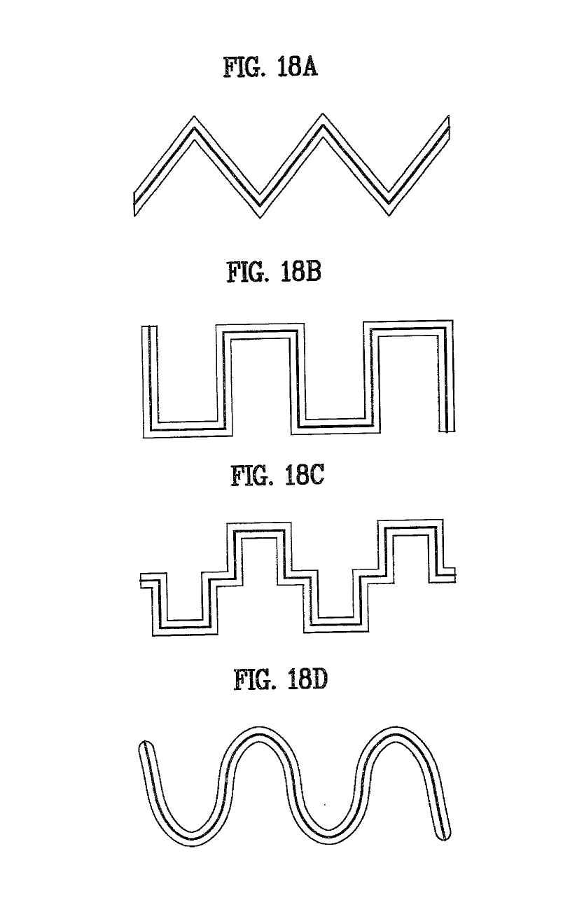

FIGS. 15 to 17 illustrate different shapes of electrode plates, as compared to the flat metal plate used in FIGS. 14A and 14B. FIG. 15A is a perspective view of a side electrode, and FIG. 15B is a cross-sectional view of FIG. 15A illustrating a metal plate side electrode 155 and a dielectric layer 156. Herein, the dielectric layer 156 is shaped, as shown in FIG. 15B, by using ceramic. Then, after a burning process at a high temperature, the dielectric layer 156 is formed into a desired shape. FIG. 15C illustrates a metallic side 155 having metallic protrusions formed in a direction perpendicular to the flat metal plate electrode. FIGS. 15D to 15F are a perspective view and cross-sectional views illustrating the structures of a middle electrode. Unlike the side electrode, the middle electrode requires an electrode on both sides. Therefore, protrusions are formed on both sides of the metal plate. In FIGS. 15A to 15F, a plurality of projecting electrodes are formed in a horizontal direction. Conversely, the plurality of projecting electrodes are formed in a vertical direction on the side electrode and the middle electrode in FIGS. 16A to 16F. Except for the direction, FIGS. 16A to 16F are similar to the arrangement in FIGS. 15A to 15F. In FIGS. 17A to 17F, the projecting electrodes are formed in both horizontal and vertical directions on the side electrode and the middle electrode, thereby forming a lattice pattern. Although FIGS. 17A to 17F only illustrate the lattice pattern of the electrodes, a hollow polygonal shape or a hollow tubular shape may also be included in the scope of the embodiment.

Electrodes shown in FIGS. 15 to 17 are U-shaped or tubular in order to be used for hollow electrodes. In addition to the electrodes shaped as described above, the hollow electrodes may also be shaped as shown in FIGS. 18A to 18D, wherein a metallic plate is processed into a lacerated shape, a step shape, a multiple step shape, and a sine wave shape. The hollow electrode is then formed by coating the surface of the processed metallic plate with a dielectric layer made of ceramic. Although the present embodiment is described with the electrodes shaped as mentioned above, they are only exemplary and many other different shapes may be embodied in the area lamp apparatus.

The present invention and each of the embodiments of the present invention may be carried out independently or combined with one another. For example, various forms of electrodes shown in FIGS. 14 to 17 may be applied to the embodiment illustrated in FIG. 10 or inserted in the electrode insertion hole 123 in FIG. 11.

As discussed above, a plurality of tubular channels are formed in the glass substrate in the area lamp apparatus of the present invention. Then, phosphor is deposited on the inner surface of the channels, which increases the surface area of the phosphor layer, thereby providing high luminance and efficiency. Additionally, unlike the conventional fluorescent lamp, a space occupied by the lamp is reduced. The present invention is an area light source, while the conventional halogen lamp is a point light source and the conventional fluorescent lamp is a linear light source. Therefore, sufficient illuminance may be obtained even when the overall luminance is decreased. Thus, the area lamp apparatus of the present invention is considered to be highly ergonomic.

Furthermore, the structure has only a few components and the fabricating process is relatively simple. Also, the side electrode substrates and the middle substrates, which have the most complicated fabricating process, require relatively small space in the apparatus, thereby allowing the apparatus to be fabricated at a low cost. More specifically, according to the present invention, a plurality of the side electrode substrates and middle electrode substrates may be formed simultaneously. The electrode substrates may also be cut from a single large substrate.

Also, by inserting a middle electrode substrate in the middle portion on the rear substrate, a large-sized insertion-type area lamp apparatus can be formed in the present invention.

Finally, a variety of hollow electrodes having complicated shapes may be used as side electrodes and middle electrodes. Therefore, a highly efficient area lamp apparatus is formed at a low cost.

In the present invention, since only a small number of parts are required, a fabrication cost is reduced. In addition, the present invention is formed of a barrier discharge structure, whereby an electrode is coated with a dielectric layer and an MgO protective layer. Such a structure ensures long-term durability of the apparatus.

It will be apparent to those skilled in the art that various modifications and variations can be made in the area lamp apparatus of the present invention without departing from the spirit or scope of the inventions. Thus, it is intended that the present invention covers the modifications and variations of this invention provided they come within the scope of the appended claims and their equivalents.

What is claimed is:

1. An area lamp apparatus comprising:
front and rear substrates facing into each other and at least a portion of the front and rear substrates contacting each other;
a plurality of groves in at least one of the front and rear substrates to form a plurality of discharge channels;
a fluorescent layer on surfaces of the groves;
a pair of side substrates attached to the front and rear substrates for sealing the discharge channels; and
a pair of side electrodes on the side substrates.

2. The area lamp apparatus according to claim 1, further comprising a reflecting layer between the fluorescent layer and the surfaces of the groves.

3. The area lamp apparatus according to claim 1, further comprising a side dielectric layer on the side electrodes.

4. The area lamp apparatus according to claim 3, further comprising a side protective layer on the side dielectric layer.

5. The area lamp apparatus according to claim 1, further comprising:
at least one insertion grove in at least one of the front and rear substrates to divide the groves;
a middle substrate inserted into the insertion grove;
a pair of middle electrodes on both sides of the middle substrate;
a pair of middle dielectric layers on the middle electrodes; and
a pair of middle protective layer on the middle dielectric layers.

6. The area lamp apparatus according to claim 5, wherein the middle substrate has at least one protrusion on both sides of the middle substrate.

7. The area lamp apparatus according to claim 6, wherein the at least one protrusion includes one of fin shape, and hollow cylindrical shape, and hollow polygonal shape.

8. The area lamp apparatus according to claim 6, wherein the at least one protrusion encapsulates a portion of the middle electrode.

9. The area lamp apparatus according to claim 8, wherein the middle electrode has one of lacerated shape, step shape, multiple step shape, and sine-wave shape.

10. The area lamp apparatus according to claim 1, wherein the grove has one of half-spherical and rectangular cross-sections.

11. The area lamp apparatus according to claim 1, wherein each groove is separated by a ridge.

12. The area lamp apparatus according to claim 11, further comprising at least one protrusion on the ridge.

13. The area lamp apparatus according to claim 12, the protrusion is located on the ridge in one of lattice and checkerboard patterns.

14. The area lamp apparatus according to claim 1, wherein the groves are connected with one another at an area in close proximity to the side substrates, thereby facilitating a plasma generation in the discharge channels.

15. The area lamp apparatus according to claim 1, wherein the side substrates have at least one protrusion on a side facing into the discharge channels of the side substrates.

16. The area lamp apparatus according to claim 15, wherein the at least one protrusion includes one of fin shape, and hollow cylindrical shape, and hollow polygonal shape.

17. The area lamp apparatus according to claim 16, wherein the at least one protrusion encapsulates a portion of the side electrodes.

18. The area lamp apparatus according to claim 17, wherein the side electrodes have one of lacerated shape, step shape, multiple step shape, and sine-wave shape.

19. An area lamp apparatus comprising:
front and rear substrates facing into each other and at least a portion of the front and rear substrates contacting each other;
a plurality of groves at the rear substrate to form a plurality of discharge channels;
a fluorescent layer on surfaces of the groves; and
a pair of side electrodes on external surfaces of the front and rear substrates at both ends of the groves.

20. The area lamp apparatus according to claim 19, wherein the groves are connected with one another at an area in close proximity to both ends of the groves, thereby facilitating a plasma generation in the discharge channels.

21. The area lamp apparatus according to claim 19, wherein the groves are defined by at least one ridge and four side substrates on the rear substrate.

22. The area lamp apparatus according to claim 21, further comprising at least one protrusion on each ridge.

23. The area lamp apparatus according to claim 22, the protrusion is located on the ridge in one of lattice and checkerboard patterns.

24. The area lamp apparatus according to claim 19, wherein the side electrodes are formed only on side surfaces of the front and rear substrates.

25. The area lamp apparatus according to claim 19, further comprising a reflecting layer between the fluorescent layer and the surfaces of the groves.

26. The area lamp apparatus according to claim 19, wherein the grove has one of half-spherical and rectangular cross-sections.

27. The area lamp apparatus according to claim 19, wherein each groove is separated by a ridge.

28. The area lamp apparatus according to claim 27, further comprising at least one protrusion on the ridge.

29. The area lamp apparatus according to claim 28, wherein the at least one protrusion is located on the ridge in one of lattice and checkerboard patterns.

30. The area lamp apparatus according to claim 19, wherein the groves are connected with one another at an area in close proximity to the side substrates, thereby facilitating a plasma generation in the discharge channels.

31. The area lamp apparatus according to claim 19, wherein the side electrodes has at least one protrusion on sides facing into the discharge channels of the side substrates.

32. The area lamp apparatus according to claim 31, wherein the at least one protrusion includes one of fin shape, and hollow cylindrical shape, and hollow polygonal shape.

33. The area lamp apparatus according to claim 32, wherein a portion of the side electrodes is formed in the protrusion.

34. The area lamp apparatus according to claim 19, wherein the side electrodes have one of lacerated shape, step shape, multiple step shape, and sine-wave shape.

35. The area lamp apparatus according to claim 19, further comprising:
at least one insertion grove in at least one of the front and rear substrates to divide the groves;
a middle substrate inserted into the insertion grove;
a pair of middle electrodes on both sides of the middle substrate;
a pair of middle dielectric layers on the middle electrodes; and
a pair of middle protective layer on the middle dielectric layers.

36. The area lamp apparatus according to claim 35, wherein the middle substrate has at least one protrusion on both sides of the middle substrate.

37. The area lamp apparatus according to claim 36, wherein the at least one protrusion includes one of fin shape, and hollow cylindrical shape, and hollow polygonal shape.

38. The area lamp apparatus according to claim 37, wherein the at least one protrusion encapsulates a portion of the middle electrode.

39. The area lamp apparatus according to claim 28, wherein the middle electrode has one of lacerated shape, step shape, multiple step shape, and sine-wave shape.

40. An area lamp apparatus comprising:
a substrate;
at least one discharge channel in the substrate;
a fluorescent layer on a surface of the discharge channel;
a pair of side substrates attached to the discharge substrate for sealing the discharge channels; and
a pair of side electrodes on the side substrates.

41. The area lamp apparatus according to claim 40, further comprising a reflecting layer between the fluorescent layer and surfaces of the discharge channels.

42. The area lamp apparatus according to claim 40, further comprising a side dielectric layer on the side electrodes.

43. The area lamp apparatus according to claim 40, further comprising a side protective layer on the side dielectric layer.

44. The area lamp apparatus according to claim 13, further comprising:
at least one insertion grove in the discharge substrate to divide the groves;
at least one middle substrate inserted into the insertion grove;
a pair of middle electrodes on both sides of the middle substrate;
a pair of middle dielectric layers on the middle electrodes; and
a pair of middle protective layer on the middle dielectric layers.
